(19) United States
(12) Patent Application Publication
(10) Pub. No.: US 2006/0031117 A1
(43) Pub. Date: Feb. 9, 2006

(54) System for dynamic advertising in software applications

(76) Inventors: Meir Zohar, Givat Shmuel (IL); Shizaf Shunari, Tel-Aviv (IL); Ziv Ayalon, Hod Hasharon (IL); Zachi Har Even, Netanya (IL); Yishai Barak, Ramat Hasharon (IL)

Correspondence Address: DANIEL J SWIRSKY, 55 REUVEN ST., BEIT SHEMESH, 99544, IL

(21) Appl. No.: 10/861,924

(22) Filed: Jun. 7, 2004

(51) Int. Cl. G07G 1/14; G07G 1/00

(52) U.S. Cl. 705/14

(57) ABSTRACT

An advertising system including a client computer, and a promoter operative on the client to a) transmit a request for instructions to an advertising server via a communication channel, where the instructions includes any of links to advertisements and times associated with the links, b) receive the instructions therefrom, and c) execute the instructions.

### FIELD OF THE INVENTION

The present invention relates to software-based advertising in general, and more particularly to the dynamic retrieval and publication of software-based advertisements.

### BACKGROUND OF THE INVENTION

The goal of an advertiser is to efficiently promote a product, such as merchandise or services, to an audience. The success of an advertiser may be greatly enhanced if the advertiser promotes the correct product to an appropriate audience, i.e. potential customers of the product. Targeted advertising campaigns attempt to do this by focusing a particular product on a select group of potential customers.

Another important factor in the success of the promotion of a product is the medium employed. “The medium is the message” may be true, but the real-life constraints often limit the medium that can be utilized. This is particularly true in Internet advertising in which the limited knowledge of the audience and the difficulty in controlling the medium aggravate the problem. The advertiser may be unable to ascertain personal information about the Internet user, since the privacy of the Internet user is often protected by law or by the anonymous nature of the Internet, and hence is unable to target the Internet user effectively. Furthermore, while an Internet advertiser may attempt to display an advertisement in the browser of an Internet user, there is no guarantee that the user will see the advertisement.

Thus, while the Internet offers a fantastic means for transporting advertisements, their efficacy is considered by many to be limited.

### SUMMARY OF THE INVENTION

In one aspect of the present invention an advertising system is provided including a client computer, and a promoter operative on the client to a) transmit a request for instructions to an advertising server via a communication channel, where the instructions includes any of links to advertisements and times associated with the links, b) receive the instructions therefrom, and c) execute the instructions.

In another aspect of the present invention the request for instructions includes a request for advertisements relevant to the client in accordance with a relevance measure.

In another aspect of the present invention the promoter is operative to retrieve from a creative server any of the advertisements indicated in the instructions.

In another aspect of the present invention the promoter is operative to analyze the instructions prior to executing the instructions and determine a method of their execution in accordance with a policy.

In another aspect of the present invention the advertising includes an advertising database for storing advertising meta-information.

In another aspect of the present invention the system further includes an application executable by the client, where the promoter is operative to receive status information from the application, the status information relating to either of the client and the application, and where the request for instructions includes the status information.

In another aspect of the present invention the request for instructions includes information derived from the status information.

In another aspect of the present invention the system further includes a sensor operative to detects sensory input outside of the client.

In another aspect of the present invention the request for instructions includes information provided by the sensor.

In another aspect of the present invention the advertising server is operative to instruct the promoter to retrieve an advertisement associated with any aspect of the information in accordance with predefined logic.

In another aspect of the present invention the advertising server is operative to discern information regarding either of the client and the promoter in addition to the information received from the promoter.

In another aspect of the present invention the promoter is operative to retrieve any of the advertisements for storage in a cache.

In another aspect of the present invention the promoter is operative to retrieve any of the advertisements in the cache whether or not the client is currently connected to a network.

In another aspect of the present invention the promoter is operative to periodically receive messages that convey trigger information occurring at the client.

In another aspect of the present invention the promoter is operative to determine a response to the trigger in accordance with a set of heuristics.

In another aspect of the present invention the promoter is operative to determine a response to the trigger in accordance with a response to trigger information received from the advertising server.

In another aspect of the present invention the response is associated with a cached advertisement.

In another aspect of the present invention the system further includes a displayer operative to render the advertisement on either of a monitor of the client and a speaker of the client.

In another aspect of the present invention the displayer is operative to verify the viability of the advertisement before rendering the advertisement on the client.

In another aspect of the present invention the displayer is operative to verify that an advertising window within the application is visible prior to rendering the advertisement on the client.

In another aspect of the present invention the displayer is operative to notify the promoter upon the successftil rendering of the advertisement, and where the promoter is operative to track display statistics of the advertisement.

In another aspect of the present invention the promoter is operative to notify the advertising server of the display statistics.

In another aspect of the present invention the promoter is operative to retrieve a plurality of the advertisements concurrently.

In another aspect of the present invention the promoter is operative to convert the instructions into a rendering description language.

In another aspect of the present invention the system further includes a displayer operative to render the converted instructions on the client, thereby rendering any advertisements indicated therein.

In another aspect of the present invention an advertising method is provided including transmitting a request for instructions to an advertising server via a communication channel, where the instructions includes any of links to advertisements and times associated with the links, receiving the instructions therefrom, and executing the instructions at a client computer.

In another aspect of the present invention the transmitting step includes requesting advertisements relevant to the client in accordance with a relevance measure.

In another aspect of the present invention the method further includes retrieving from a creative server any of the advertisements indicated in the instructions.

In another aspect of the present invention the method further includes analyzing the instructions prior to executing the instructions and determine a method of their execution in accordance with a policy.

In another aspect of the present invention the method further includes receiving status information from an application, the status information relating to either of the client and the application, and where the transmitting step includes transmitting the status information.

In another aspect of the present invention the transmitting step includes transmitting information derived from the status information.

In another aspect of the present invention the method further includes detecting sensory input outside of the client.

In another aspect of the present invention transmitting step includes transmitting information provided by the sensor.

In another aspect of the present invention the method further includes retrieving an advertisement associated with any aspect of the information in accordance with predefined logic.

In another aspect of the present invention the method further includes discerning information regarding the client in addition to the received information.

In another aspect of the present invention the method further includes retrieving any of the advertisements for storage in a cache.

In another aspect of the present invention the method further includes retrieving any of the advertisements in the cache whether or not the client is currently connected to a network.

In another aspect of the present invention the method further includes periodically receiving messages that convey trigger information occurring at the client.

In another aspect of the present invention the method further includes determining a response to the trigger in accordance with a set of heuristics.

In another aspect of the present invention the method further includes determining a response to the trigger in accordance with a response to trigger information received from an advertising server.

In another aspect of the present invention the determining step includes associating the response with a cached advertisement.

In another aspect of the present invention the method further includes rendering the advertisement on either of a monitor of the client and a speaker of the client.

In another aspect of the present invention the method further includes verifying the viability of the advertisement before rendering the advertisement on the client.

In another aspect of the present invention the method further includes verifying that an advertising window within an application is visible prior to rendering the advertisement on the client.

In another aspect of the present invention the method further includes notifying a promoter upon the successful rendering of the advertisement, and where the promoter is operative to track display statistics of the advertisement.

In another aspect of the present invention the method further includes notifying an advertising server of the display statistics.

In another aspect of the present invention the method further includes retrieving a plurality of the advertisements concurrently.

In another aspect of the present invention the method further includes notifying converting the instructions into a rendering description language.

In another aspect of the present invention the method further includes rendering the converted instructions on the client, thereby rendering any advertisements indicated therein.

It is appreciated throughout the specification and claims that the term “advertisement” may refer to any form of communication between an advertiser and an audience, such as an audio and/or visual presentation.

### BRIEF DESCRIPTION OF THE DRAWINGS

The present invention will be understood and appreciated more fully from the following detailed description taken in conjunction with the appended drawings in which:

FIG. 1 is a simplified pictorial illustration of an advertising system, constructed and operative in accordance with a preferred embodiment of the present invention;

FIG. 2 is a simplified pictorial illustration of a caching system, constructed and operative in accordance with a preferred embodiment of the present invention;

FIG. 3 is a simplified flow chart illustration of a method for rendering stored advertisements, operative in accordance with a preferred embodiment of the present invention;

FIG. 4 is a simplified flow chart illustration of a method for preparing large binary advertisements, operative in accordance with a preferred embodiment of the present invention; and

FIG. 5 is a simplified flow chart illustration of a method for preparing HTML documents, operative in accordance with a preferred embodiment of the present invention.

### DETAILED DESCRIPTION OF PREFERRED EMBODIMENTS

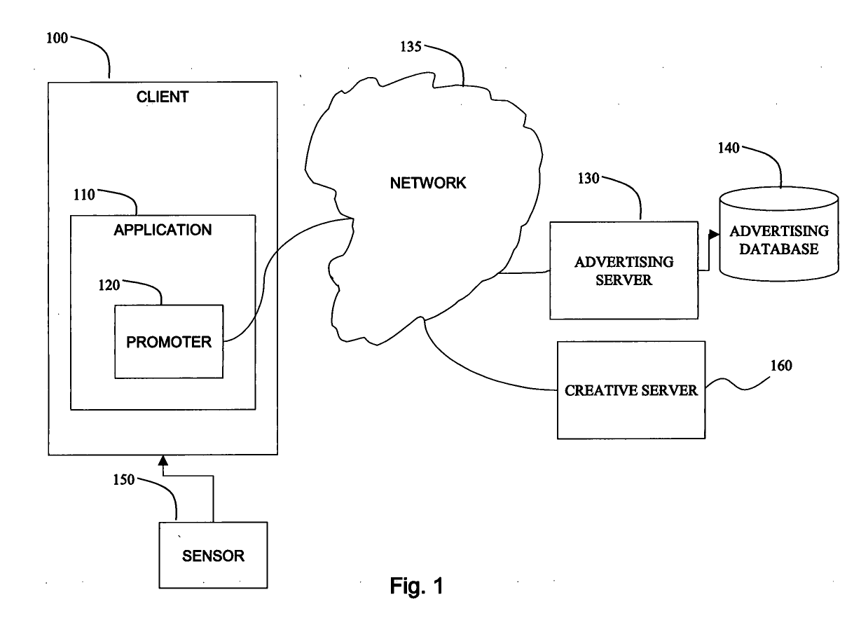

Reference is now made to FIG. 1, which is a simplified pictorial illustration of an advertising system, constructed and operative in accordance with a preferred embodiment of the present invention. A client 100, such as a personal computer, may execute an application 110, such as a word processor, that preferably incorporates a promoter 120. Application 110 may communicate to promoter 120 over an application programming interface (API), such as a set of function calls, information relating to the application's life-cycle, as well as other forms of information such as those relating to the current status of the application 110 or client 100. Promoter 120 is preferably capable of creating a communication channel to an advertising server 130 over a network 135, such as the Internet. Promoter 120 preferably transmits to advertising server 130 a request for instructions, such as a request for advertisements relevant to client 100, using any known relevance measure. Furthermore, the request may include the information communicated by application 110, or information derived therefrom. For example, application 110 may communicate to promoter 120 its application type, e.g., an office application. Promoter 120 may additionally have a communication channel, such as a USB connection, to information provided by a sensor 150. Sensor 150 typically detects sensory input outside of client 100, such as the temperature. The information is provided by sensor 150 may also be included in the request sent by promoter 120 to advertising server 130.

Advertising server 130 preferably employs an advertising database 140 to store advertising meta-information, such as the categorizations of particular advertising campaigns. For example, an advertising campaign for women's shoes may fall under the general category of ‘apparel’ and may also appear in the category of ‘women’. The information communicated by promoter 120 may indicate to advertising server 130 which types of advertisements stored in advertising database 140 are relevant to client 100. Advertising server 130 preferably constructs a set of instructions for promoter 120, such as links to advertisements and times associated with the links, that satisfies the request sent by promoter 120 and that may be based on the information provided by promoter 120. For example, promoter 120 may send the following request to advertising server 130:
GET/list_of_adds.asp?locale=en&temperature=85F&application_class=office HTTP/1.0

Advertising server 130 after consultation with advertising database 140 may respond:

HTTP/1.0 200 OK
Date: today
Connection-Type: close
Content-type: text/instruction-set
<ad>

<url=http://adserver.com/air_conditioning/en/ad1.gif />
<time=today />

</ad>
<ad>

<url=http://adserver.com/air_conditioning/en/ad2.gif />
<time=tomorrow />

</ad>

In this sequence, promoter 120 requested a set of instructions for a client 100 whose locale is set to ‘en’, for U.S. English, whose ambient room temperature is 85 degrees Fahrenheit, and who is running an office application. Moreover, advertising server 130 may detect other types of information regarding promoter 120 from the request sent by promoter 120, such as the IP address of client 100. In response, advertising server 130 preferably queries advertising database 140 using predefined logic for advertisements that are appropriate for a consumer who resides in a U.S. English locale, is sitting in a room whose ambient temperature is 85 degrees Fahrenheit, and is running an office application. In the present example, such a query yields two advertisements for air conditioning. Advertising server 130 then constructs a set of instructions for promoter 120 that includes links to the advertisements to be retrieved and rendered. In the present example, the instructions also indicate that the first advertisement is to be run today, and the second, tomorrow.

Promoter 120 preferably attempts to follow the instructions received from advertising server 130 that typically include the retrieval of advertisements from a creative server 160. Creative server 160 typically is designed to store binary advertisements, such as GIF images and MPEG movies, and facilitate their retrieval through a common protocol such as HTTP. Moreover, promoter 120 may analyze the instructions in their entirety, prior to their fulfillment to determine an efficient method of their fulfillment in accordance with predefined policies, such as retrieving advertisements that reside on the same advertising server 130 within a single HTTP 1.1 session.

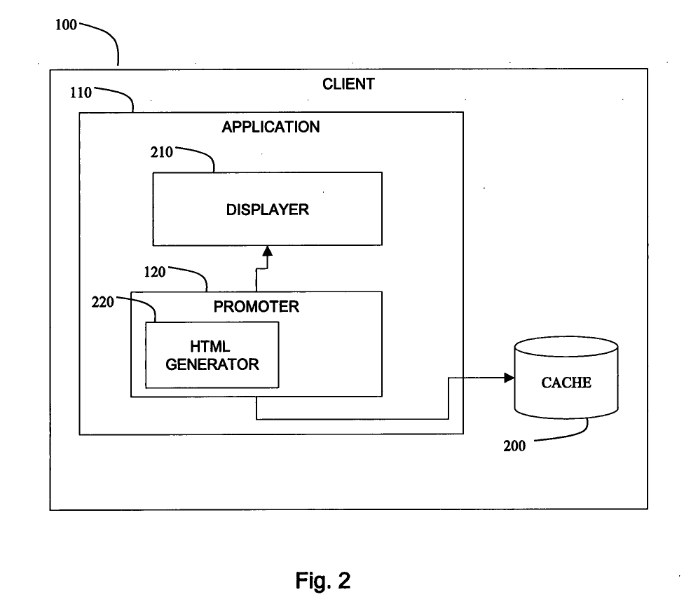

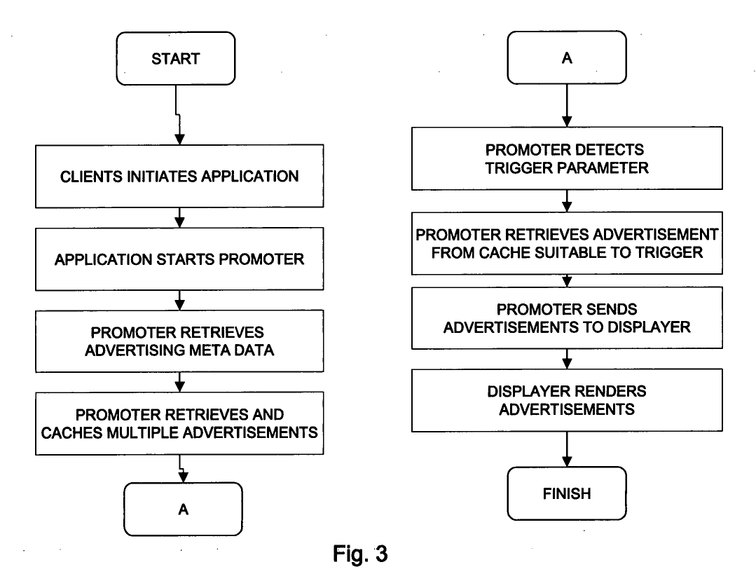

Reference is now made to FIG. 2, which is a simplified pictorial illustration of a caching system, constructed and operative in accordance with a preferred embodiment of the present invention, and to FIG. 3, which is a simplified flow chart illustration of a method for rendering stored advertisements, operative in accordance with a preferred embodiment of the present invention. When client 100 initiates application 110, application 110 preferably causes promoter 120 to begin execution and retrieve instructions from advertising server 130 as described hereinabove. Promoter 120 preferably retrieves the advertising content specified by the instructions and caches the advertisement in a cache 200, such as a in set of flat files. The retrieval of information stored in cache 200 is independent of the status of the external connectivity of client 100”, such as the connectivity of client 100 to network 135, and the information may be retrieved from cache 200 at the convenience of promoter 120.

Promoter 120 may then receive periodic messages, such as those from client 100 or application 110, that convey trigger information, such as the keyboard activity of client 110. Promoter 120 preferably includes a predefined set of heuristics that determines the response to trigger information. For example, promoter 120 may interpret keyboard activity as an indicator of the presence of a user of client 100 and hence an appropriate time to render the advertisement. Alternatively, promoter 120 may receive instructions from advertising server 130 that defines a response to trigger information. For example, advertising server 130 may request that a particular advertisement, such as an advertisement for new keyboards, be rendered only when there is a lack of keyboard activity. In this manner, the response of promoter 120 to trigger information may be dynamically modified and may better reflect the nature of an advertisement campaign.

Once triggered, promoter 120 preferably retrieves the relevant advertisements from cache 200 and transmits them to a displayer 210. Displayer 210 preferably verifies the viability of an advertisement before rendering the advertisement on client 100, such as by displaying the advertisement on a monitor of client 100 and/or playing the advertisement over a speaker of client 100. For example, displayer 210 may detect the visibility of an advertising window within the application 110 and delay the rendering of the advertisements such that the advertisement is rendered at a time when the advertising window is completely visible. Displayer 210 preferably notifies promoter 120 upon the successful rendering of an advertisement, enabling promoter 120 to track the display statistics of each advertisement. Promoter 120 preferably retains a communication path with advertising server 130 through which promoter 120 may notify advertising server of information, such as the display statistics, and advertising server 130 may transmit important information to promoter 120. For example, promoter 120 may request a small GIF image from creative server 160. Advertising server 120 may monitor creative server 130 and calculate from the number of requests for the small GIF image the number of successful displays of a particular advertisement. At the same time, promoter 120 may monitor the content of the small GIF image and based on its content determine to perform an action, such a refresh cache 200.

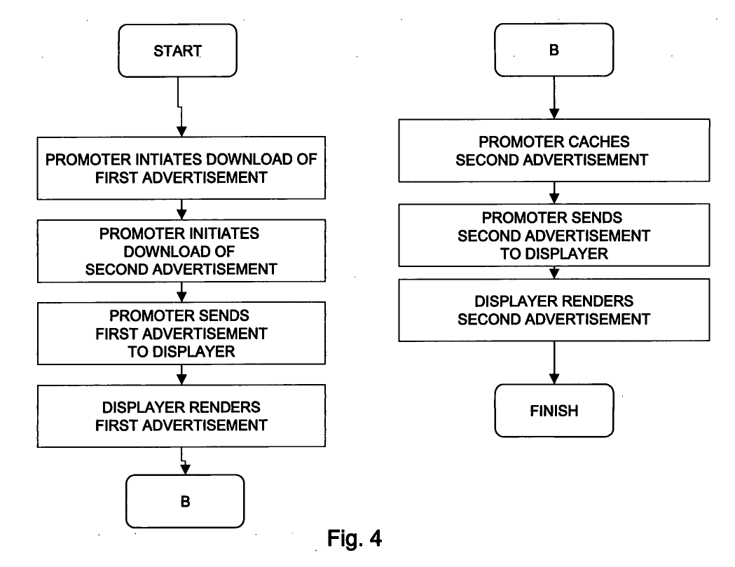

Reference is now made to FIG. 4, which is a simplified flow chart illustration of a method for preparation of large binary advertisements, operative in accordance with a preferred embodiment of the present invention. In the method of FIG. 4, promoter 120 may receive instructions to display multiple advertisements, where one of the advertisements may have a substantially larger file size than the others. For example, a first advertisement may include text and an image, while a second advertisement may include a movie. Promoter 120 preferably initiates the download of the second advertisement into cache 200 while concurrently downloading the first advertisement. Due to the difference in size, the first advertisement may be available prior to the second. Promoter 120 may then send the first advertisement to displayer 210, which in turn renders the advertisements immediately, while promoter 120 continues to download the second advertisement to cache 200. At an appropriate time, such as in reaction to a trigger, subsequent to the conclusion of the download of the second advertisement, promoter 120 may send the second advertisement to displayer 210.

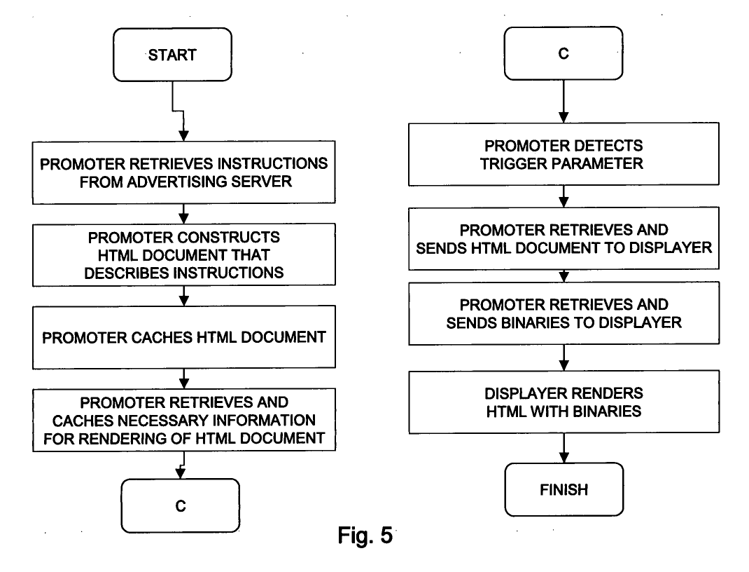

Reference is now made to FIG. 5, which is a simplified flow chart illustration of a method for preparation of HTML documents, operative in accordance with a preferred embodiment of the present invention. In the method of FIG. 5, promoter 120 preferably converts the instructions received from advertising server 130 into an efficient description language ready for immediate rendering, such as HTML. The converted instructions may then be stored in cache 200 while the promoter concludes the download of associated files, such as binary images. When the promoter 120 decides, such as in response to a trigger, to send the advertisement to the displayer 210, promoter 120 may retrieve the prepared converted instructions and their associated binaries from cache 200. Displayer 210 may then immediately render the prepared converted instructions without further delay.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. An advertising system comprising:
a client computer; and
a promoter operative on said client to:
transmit a request for instructions to an advertising server via a communication channel, wherein said instructions includes any of links to advertisements and times associated with said links,
receive said instructions therefrom, and
execute said instructions.

2. A system according to claim 1 wherein said request for instructions comprises a request for advertisements relevant to said client in accordance with a relevance measure.

3. A system according to claim 1 wherein said promoter is operative to retrieve from a creative server any of said advertisements indicated in said instructions.

4. A system according to claim 1 wherein said promoter is operative to analyze said instructions prior to executing said instructions and determine a method of their execution in accordance with a policy.

5. A system according to claim 1 wherein said advertising includes an advertising database for storing advertising meta-information.

6. A system according to claim 1 and further comprising an application executable by said client, wherein said promoter is operative to receive status information from said application, said status information relating to either of said client and said application, and wherein said request for instructions comprises said status information.

7. A system according to claim 6 wherein said request for instructions comprises information derived from said status information.

8. A system according to claim 6 and further comprising a sensor operative to detects sensory input outside of said client.

9. A system according to claim 8 wherein said request for instructions comprises information provided by said sensor.

10. A system according to claim 6 wherein said advertising server is operative to instruct said promoter to retrieve an advertisement associated with any aspect of said information in accordance with predefined logic.

11. A system according to claim 6 wherein said advertising server is operative to discern information regarding either of said client and said promoter in addition to said information received from said promoter.

12. A system according to claim 1 wherein said promoter is operative to retrieve any of said advertisements for storage in a cache.

13. A system according to claim 12 wherein said promoter is operative to retrieve any of said advertisements in said cache whether or not said client is currently connected to a network.

14. A system according to claim 1 wherein said promoter is operative to periodically receive messages that convey trigger information occurring at said client.

15. A system according to claim 14 wherein said promoter is operative to determine a response to said trigger in accordance with a set of heuristics.

16. A system according to claim 14 wherein said promoter is operative to determine a response to said trigger in accordance with a response to trigger information received from said advertising server.

17. A system according to claim 15 wherein said response is associated with a cached advertisement.

18. A system according to claim 3 and further comprising a displayer operative to render said advertisement on either of a monitor of said client and a speaker of said client.

19. A system according to claim 18 wherein said displayer is operative to verify the viability of said advertisement before rendering said advertisement on said client.

20. A system according to claim 18 wherein said displayer is operative to verify that an advertising window within said application is visible prior to rendering said advertisement on said client.

21. A system according to claim 18 wherein said displayer is operative to notify said promoter upon the successful rendering of said advertisement, and wherein said promoter is operative to track display statistics of said advertisement.

22. A system according to claim 21 wherein said promoter is operative to notify said advertising server of said display statistics.

23. A system according to claim 3 wherein said promoter is operative to retrieve a plurality of said advertisements concurrently.

24. A system according to claim 1 wherein said promoter is operative to convert said instructions into a rendering description language.

25. A system according to claim 24 and further comprising a displayer operative to render said converted instructions on said client, thereby rendering any advertisements indicated therein.

26. An advertising method comprising:
transmitting a request for instructions to an advertising server via a communication channel, wherein said instructions includes any of links to advertisements and times associated with said links,
receiving said instructions therefrom, and
executing said instructions at a client computer.

27. A method according to claim 26 wherein said transmitting step comprises requesting advertisements relevant to said client in accordance with a relevance measure.

28. A method according to claim 26 and further comprising retrieving from a creative server any of said advertisements indicated in said instructions.

29. A method according to claim 26 and further comprising analyzing said instructions prior to executing said instructions and determine a method of their execution in accordance with a policy.

30. A method according to claim 26 and further comprising receiving status information from an application, said status information relating to either of said client and said application, and wherein said transmitting step comprises transmitting said status information.

31. A method according to claim 30 wherein said transmitting step comprises transmitting information derived from said status information.

32. A method according to claim 30 and further comprising detecting sensory input outside of said client.

33. A method according to claim 32 wherein transmitting step comprises transmitting information provided by said sensor.

34. A method according to claim 30 and further comprising retrieving an advertisement associated with any aspect of said information in accordance with predefined logic.

35. A method according to claim 30 and further comprising discerning information regarding said client in addition to said received information.

36. A method according to claim 26 and further comprising retrieving any of said advertisements for storage in a cache.

37. A method according to claim 36 and further comprising retrieving any of said advertisements in said cache whether or not said client is currently connected to a network.

38. A method according to claim 26 and further comprising periodically receiving messages that convey trigger information occurring at said client.

39. A method according to claim 38 and further comprising determining a response to said trigger in accordance with a set of heuristics.

40. A method according to claim 38 and further comprising determining a response to said trigger in accordance with a response to trigger information received from an advertising server.

41. A method according to claim 39 wherein said determining step comprises associating said response with a cached advertisement.

42. A method according to claim 28 and further comprising rendering said advertisement on either of a monitor of said client and a speaker of said client.

43. A method according to claim 42 and further comprising verifying the viability of said advertisement before rendering said advertisement on said client.

44. A method according to claim 42 and further comprising verifying that an advertising window within an application is visible prior to rendering said advertisement on said client.

45. A method according to claim 42 and further comprising notifying a promoter upon the successful rendering of said advertisement, and wherein said promoter is operative to track display statistics of said advertisement.

46. A method according to claim 45 and further comprising notifying an advertising server of said display statistics.

47. A method according to claim 28 and further comprising retrieving a plurality of said advertisements concurrently.

48. A method according to claim 26 and further comprising notifying converting said instructions into a rendering description language.

49. A method according to claim 48 and further comprising rendering said converted instructions on said client, thereby rendering any advertisements indicated therein.
